(19) United States
(12) Patent Application Publication
(10) Pub. No.: US 2018/0005141 A1
(43) Pub. Date: Jan. 4, 2018

(54) INTELLIGENT UPGRADE OFFERING FOR A LISTING

(71) Applicant: eBay Inc., San Jose, CA (US)

(72) Inventors: Girish Vasvani, Fremont, CA (US); Gaurav Lokesh, Dublin, CA (US); Michael Alley, San Francisco, CA (US); Clifford Lyon, San Jose, CA (US); Xiaofan Xu, San Jose, CA (US)

(21) Appl. No.: 15/201,062

(22) Filed: Jul. 1, 2016

(51) Int. Cl. G06Q 10/02; G06Q 30/06

(52) U.S. Cl. CPC G06Q 10/02; G06Q 30/0631

(57) ABSTRACT

A method of generating a user-interface to be displayed at a remote location. The method may include receiving a selection of an item listing for an event from a user at a remote location and determining an upgrade offering for the item listing based on previously accepted upgrade offers. The method may additionally include generating instructions to be transmitted to the remote location to generate a user interface to be displayed at the remote location. The user interface may include the item listing and an interactive element for selecting the upgrade offering. The method may also include transmitting the instructions to the remote location.

### FIELD

The embodiments discussed in the present disclosure are related to an intelligent upgrade offering for a listing.

### BACKGROUND

With the proliferation of buying and selling of goods and services on the Internet, the large number of goods and services available can pose problems to a user in finding what the user is looking for. Additionally, the user may be unaware if there is a good or service better suited to the user.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example system that may be used to present an intelligent upgrade offering to a user;

FIG. 2 illustrates an example of a user interface that includes an intelligent upgrade offering;

FIG. 3 illustrates an example venue map;

FIG. 4 illustrates another example of a venue map;

FIG. 5 illustrates a flowchart of an example computer-implemented method of providing an intelligent upgrade offering; and

FIG. 6 illustrates a flowchart of another example computer-implemented method of providing an intelligent upgrade offering.

### DESCRIPTION OF EMBODIMENTS

Some embodiments of the present disclosure may relate to systems and methods of providing intelligent upgrade offerings of purchases. In some embodiments, a user may select a particular listing to make a purchase of a good or service (e.g., the user may click on a hyperlink of a listing for a ticket to an event to see additional details regarding the ticket). Based on a variety of factors (e.g., previous success of upgrades, physical location of the user, context of the event, etc.), an intelligent upgrade may be presented to the user in addition to the information regarding the selected listing. In particular, the present disclosure may include methods and systems that may include considering a variety of factors in determining an intelligent upgrade offering to be provided to the user. With respect to some purchases with a large number of possible upgrade options and offerings (e.g., ticket sales), such a process may be used to overcome the particularly difficult or daunting problems associated with providing upgrade offerings.

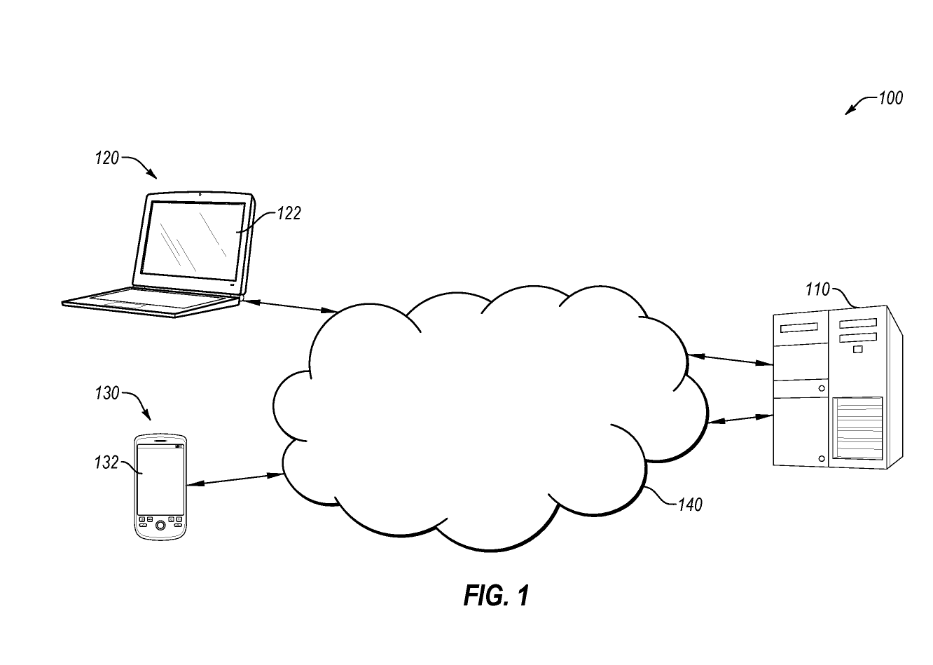

Turning to the figures, FIG. 1 illustrates an example system 100 that may be used to present an intelligent upgrade offering to a user, in accordance with one or more embodiments of the present disclosure. The system 100 may include a server 110, a first device 120 with a display 122, a second device 130 with a display 132, and a network 140. The first device 120 and/or the second device 130 may operate as a requesting device and may submit a selection of an item listing for an event or otherwise query the server 110 for listings of goods or services for sale. The server 110 may generate instructions that direct or instruct the requesting device to generate a user interface to be displayed at the requesting device.

For example, a user operating the first device 120 may enter user input via a user interface of the first device 120 to request the details of a ticket for sale for a given event. In response to the user input, the first device 120 may transmit the request over the network 140 to the server 110. The server 110 may retrieve the details of the ticket in response to receiving the request. Additionally, in some embodiments, the server 110 may determine an upgrade offering to the ticket that may be presented to the user in addition to the details of the ticket. For example, the server 110 may consider a variety of factors and provide the user with an intelligent upgrade offering based on the consideration of the factors by the server 110. In some embodiments, the intelligent upgrade offering may be based on previously selected user preferences, such as preferred sections of a venue, preferred events, preferred seats, etc. In some embodiments, the intelligent upgrade offering may be based on factors or considerations that are derived from user-specific factors that are not selected by the user and/or event-specific factors (e.g., in some embodiments, the intelligent upgrade offering may be independent of user-selected preferences for upgrade offerings).

In some embodiments, the server 110 may include user-specific factors in determining an upgrade offering. For example, the server 110 may track the purchase history of the user, which may include the purchase history of the user generally or may include the purchase history of the user in the context of a network-based commerce system such as one that may be used by eBay®, StubHub®, etc. of which the server 110 may be a part. As one example, if the user has been a frequent purchaser of tickets for events, the server 110 may offer a higher value upgrade and/or a better price for the upgrade. As another example, if the user has purchased goods or services related to the event (e.g., the user has purchased a guitar and the event is a concert of a famous guitar player, or the user has purchased autographed sports paraphernalia and the event is a sporting event involving the player or team of the purchased paraphernalia), the server 110 may offer a higher value upgrade. As an additional example, if the user has always purchased tickets below a certain dollar amount, the server 110 may offer an upgrade offering within that dollar amount.

In some embodiments, the server 110 may track and/or utilize the purchase history of the user with respect to upgrades in determining an upgrade offering. For example, the server 110 may track instances when the user has accepted an upgrade offering. The server 110 may use such instances in making an intelligent upgrade offering. For example, if the user has previously accepted upgrade offerings, a higher value upgrade offering may be provided. As another example, if the user has only accepted upgrade offerings that are a certain percentage over the originally selected listing price, the server 110 may limit the upgrade offerings provided to the user to upgrade offerings that may fall within that certain percentage. As an additional example, if the user has never accepted an upgrade offering, the server 110 may provide a low value upgrade offering.

In some embodiments, the server 110 may track and/or utilize other interactions of the user with an electronic system in determining an upgrade offering. For example, the first device 120 may store the interactions of the user with the first device 120 when interacting with an interactive visual element of a user interface and may provide those interactions to the server 110. In some embodiments, the server 110 may provide instructions to the first device 120 to display an interactive venue map of the venue hosting the event. The first device 120 may track which sections of the venue map the user selects, how frequently the user selects the various sections, how long the user keeps one section active, etc. The first device 120 may transmit data representing such interactions to the server 110. The server 110 may use the interactions to determine what upgrade to offer. For example, if the user frequently interacted with a lower-bowl section of the interactive map of the venue, but selected a seat in an upper-bowl of the venue, the server 110 may determine that an upgrade offering from the lower-bowl section may be offered. As another example, if the user interacted with the first device 120 to view multiple sections, the server 110 may determine that an upgrade offering from the most recently viewed section with higher value tickets than a currently selected listing may be selected to be offered to the user.

In some embodiments, the server 110 may utilize other listings or attributes of listings with which the user has interacted. For example, if the user has selected one or more listings and indicated to the server 110 that the user would like to come back at a later time to revisit the listings (e.g., saved the listings for later viewing), the server 110 may utilize the listings and/or one or more of the attributes of the listings in determining an upgrade offering. For example, listings saved for later by a user may indicate a strong preference for such a listing, and similar or comparable listings may suggest a higher value listing as the offering. Such attributes may include the type of seat (e.g., aisle seat, middle of the row, etc.), location of seat (e.g., front row, particular section/zone, etc.). As another example, one or more of the saved listings and/or a similar listing may be provided as the upgrade offering.

In some embodiments, the server 110 may utilize location information of the user in determining an upgrade offering. For example, the server 110 may have received the address of the user when making a previous credit card purchase. As another example, the server 110 may determine the location of the internet protocol (IP) address of the first device 120 communicating with the server 110 and may determine a physical location associated with the IP address. As an additional example, the server 110 may query location-based services of the second device 130, such as a global positioning system (GPS) tracking component of a portable computing device. Based on the location of the user (e.g., using any of the example approaches described above or any other location-determining process), the server 110 may provide an upgrade offering. For example, if the location of the user is an affluent area (e.g., a zip code with high property values or a street address of a high property value home), a high value upgrade offering may be provided to the user. As an additional example, if the location of the user is a low-income location, a low value upgrade offering may be provided to the user.

In some embodiments, the server 110 may utilize quantity information selected by the user in determining an upgrade offering. For example, the user may interact with the first device 120 to identify a given quantity of seats or tickets the user may be interested in purchasing. In these and other embodiments, the server 110 may provide an upgrade offering that includes the given quantity of seats or tickets together. For example, if the user indicated that she was seeking six tickets to an event, the server 110 may provide an upgrade offering that include six adjacent seats for the event that were superior to the selected six tickets. In these and other embodiments, an initial upgrade offering may be provided in response to a listing is first selected, and an updated upgrade offering may be provided when a given quantity is selected.

In some embodiments, event-specific factors may be utilized by the server 110 in determining an upgrade offering to the user. In some embodiments, the server 110 may determine the context of the event and use the context in determining the upgrade offering. For example, for a sporting event, the server 110 may determine whether the event is during a pre-season, a regular season, play-offs, or finals of the sporting event. In these and other embodiments, a regular season event may have a higher value upgrade offering than a pre-season event, a play-off event may have a higher value upgrade offering than a regular season event, and a finals event may have a higher value upgrade offering than a play-off event. In some embodiments, other context-factors related to a sporting event may also influence the upgrade offering. For example, the win/loss percentage of one or more of the teams involved in an event, the probability of one or more of the teams involved in the event of reaching the playoffs, the opponent being played (e.g., a rivalry game), etc. In some embodiments, the league of which a sporting event is a part may influence the upgrade offering. For example, for a highest level of a sport (e.g., National Basketball Association (NBA), National Football League (NFL), National Hockey League (NHL), Major League Baseball (MLB), Union of European Football Associations (UEFA) Champions League, etc.), a higher value upgrade offering may be determined while for lower level leagues of a sport (e.g., NBA Development League, Minor league baseball, American Hockey League (AHL), etc.), a lower value upgrade offering may be provided.

In some embodiments, context factors may also be applicable and utilized for events generally. For example, the server 110 may base the determination of an upgrade offering on a number of instances of an event (e.g., a tour of a band with three showings in one city or only one showing in the city, or a play or live comedian with seven showings or a single showing), the location of an event (e.g., a Broadway show in downtown New York vs. a Broadway show in Oklahoma City, or a playoff game occurring in Denver vs. a playoff game occurring in Los Angeles), a number of locations of an event (e.g., a band is only playing in one city, or a traveling circus is appearing in thirty cities), a percent of tickets sold to an event (e.g., an event is nearly sold out, or an event has many seats available). As another example, the server 110 may base the determination of an upgrade offering on a number of hours remaining for an event, or the amount of time remaining before an event begins (e.g., a higher value upgrade may be offered at a price lower than the normal price if there is one hour remaining in a three hour event, or prices may be lowered the closer the event gets to the starting time). In these and other embodiments, for factors that may make a ticket more exclusive, harder to get, or a higher value (e.g., fewer events, an event more likely to be sold out, etc.), the server 110 may utilize a higher value upgrade offering as demand may be higher for such an event. Additionally or alternatively, for factors that may make a ticket more exclusive, harder to get, or a higher value, a lower value upgrade offering may be offered (e.g., a lower value ticket may have the same price as a higher value ticket for other less exclusive events).

In some embodiments, upgrade success percentage for a given event may also form a part of the basis for determining the upgrade offering by the server 110. For example, for a given event that has a high percentage of upgrade success (e.g., many users are upgrading tickets for the event), higher value upgrades may be offered for the event. Additionally or alternatively, for a given event that has a low percentage of upgrade success (e.g., not many users are upgrading tickets for the event), lower value upgrades may be offered for the event.

In some embodiments, a price for the upgrade may be determined by the server 110. In these and other embodiments, one or more factors that may be used to determine the upgrade offering may be used to determine the price for the upgrade. In these and other embodiments, factors that may designate a higher value upgrade offering may increase the price for the upgrade. In some embodiments, a listing as a potential upgrade offering may be selected first, and a price for the upgrade offering may be determined second. Additionally or alternatively, a price or range of prices for an upgrade offering may be determined first, and a listing that approximates that price or approximates the price range may be determined second.

As used in the present disclosure, when referencing relative values of listings for the purpose of upgrades or determining a price, a higher value listing or seat includes one that is traditionally thought of as superior, more in demand, or commands a higher initial purchase price. For example, factors such as location (e.g., being closer to the event), view (e.g., unobstructed vs. obstructed), material (e.g., a cushion or a seat-back as opposed to a bleacher), venue location (e.g., center stage or fifty yard line), amenities (e.g., access to a VIP lounge or a dining suite), etc. may influence the value of a seat and whether it is of a “higher value” or a “lower value.”

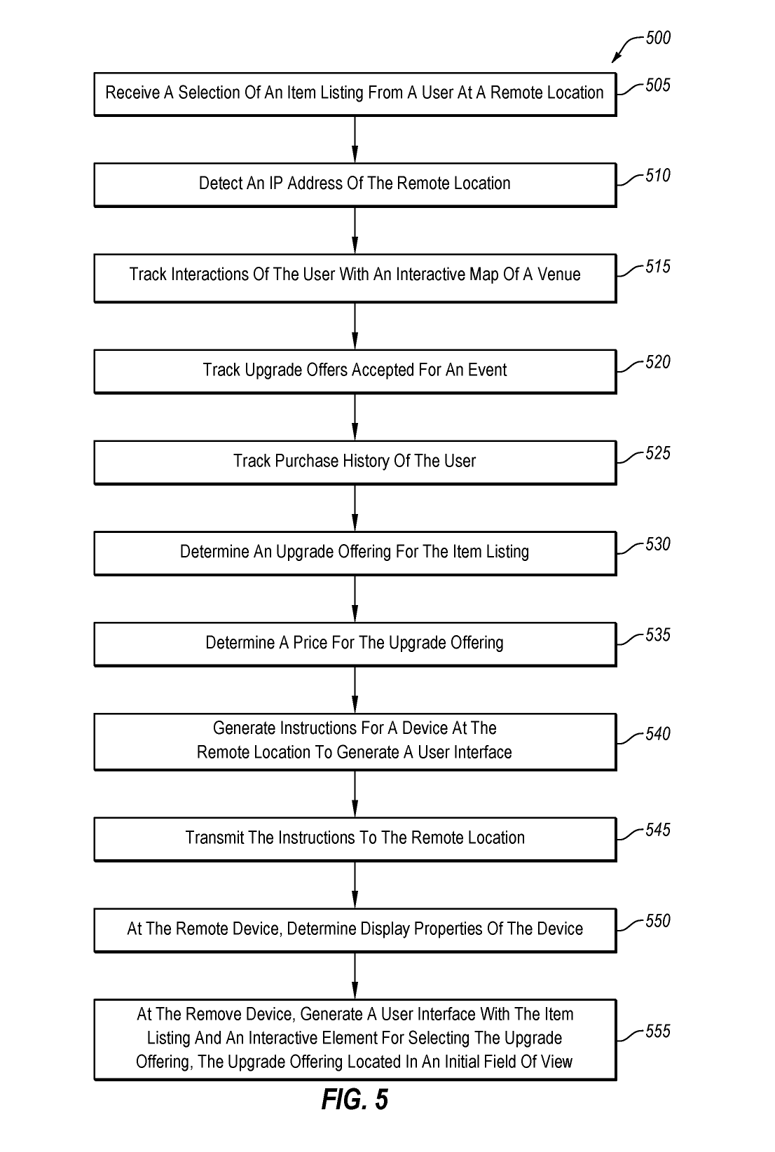

The server 110 may include any system, device, component, or combinations thereof configured to receive a selection of a listing for an event or query regarding listings and provide results, and/or determine an intelligent upgrade offering to a selected listing. While labeled as a “server,” it will be appreciated that the server 110 may be any information processing system. The server 110 may additionally be configured to perform one or more of the operations described in the present disclosure, such as one or more of the operations described with respect to FIGS. 5 and/or 6. In some embodiments, the server 110 may include a processor, a memory, and a storage device. In these and other embodiments, the server 110 may operate as part of a network-based commerce system such as eBay®, StubHub®, etc. from which the server 110 may retrieve and/or process listings. The server 110 may be implemented as any device, such as a blade server, a rack server, a desktop, a laptop, a mobile device, a tablet, etc.

The first device 120 may include any system, device, component, or combinations thereof configured to allow a user to interact with the first device 120 to input a selection of a listing to be sent to the server 110, and have the listing and an upgrade offering displayed to the user at the display 122. In some embodiments, the first device 120 may include a processor, a memory, and a storage device in addition to the display 122. The first device 120 may be implemented as any device, such as a blade server, a rack server, a desktop, a laptop, a mobile device, a tablet, etc. The display 122 may have display properties, such as resolution, viewable area, etc. In some embodiments, various aspects of a user interface may be adjusted based on the display properties of the display 122. The second device 130 may be comparable or similar to the first device 120, with a display 132.

The network 140 may include any device, system, component, or combination thereof configured to provide communication between one or more of the server 110, the first device 120, and the second device 130. By way of example, the network 140 may include one or more wide area networks (WANs) and/or local area networks (LANs) that enable the server 110, the first device 120, and/or the second device 130 to be in communication. In some embodiments, the network 140 may include the Internet, including a global internetwork formed by logical and physical connections between multiple WANs and/or LANs. Alternately or additionally, the network 140 may include one or more cellular RF networks and/or one or more wired and/or wireless networks such as, but not limited to, 802.xx networks, Bluetooth access points, wireless access points, IP-based networks, or the like. The network 140 may also include servers that enable one type of network to interface with another type of network. Additionally or alternatively, the network 140 may include an Intranet, or one or more computing devices in communication within an organization or an in otherwise secure manner.

Modifications, additions, or omissions may be made to FIG. 1 without departing from the scope of the present disclosure. For example, the system 100 may include more or fewer elements than those illustrated and described in the present disclosure. For example, the system 100 may include any number of devices or servers. As another example, the system 100 may include multiple or alternative servers that may perform one or more of the operations of the present disclosure in cooperation with the server 110.

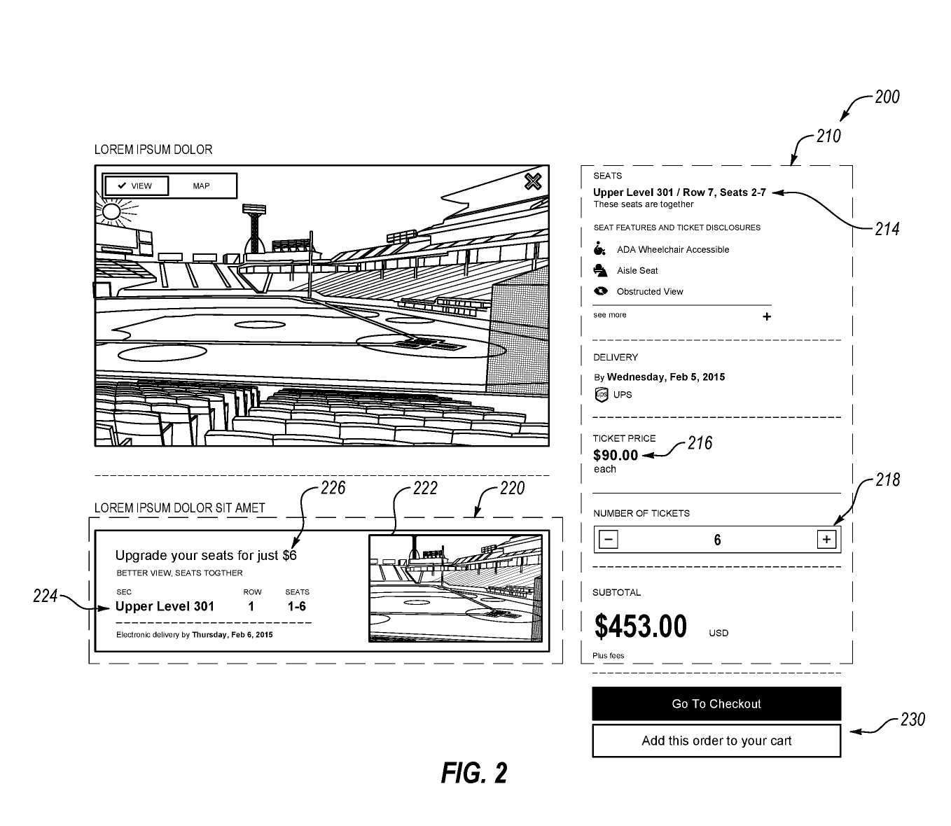

FIG. 2 illustrates an example of a user interface 200 that includes an intelligent upgrade offering, in accordance with one or more embodiments of the present disclosure. For example, a server (e.g., the server 110 of FIG. 1) may generate instructions for a device (e.g., the first device 120 and/or the second device 130 of FIG. 1) to generate the user interface 200. In some embodiments, the user interface 200 may provide an example of a display that a user may be presented with after selecting a listing.

In some embodiments, the user interface 200 may include a first region 210 that may include information regarding a listing. For example, if a user had interacted with a device to select a listing, the first region 210 may provide information regarding that listing. The first region 210 may include first location information 214 (illustrated in FIG. 2 as “Upper Level 301/Row 7, Seats 2-7”) and/or properties of the selected listing (illustrated as “ADA Wheelchair accessible,” “Aisle seat,” and “Obstructed view.” The first region 210 may include first price information 216, a quantity component 218, and a total price based on the first price information 216 and the quantity component 218.

In some embodiments, as part of the first region 210 or as a separate element of the user interface 200, the user interface 200 may include a first interactive element 212 that may represent a visualization associated with the selected listing. For example, the first interactive element 212 may depict a view of a venue hosting the event from the selected listing location. Such a view may be a computer-generated visualization of the view, or may be a photograph of the view. In some embodiments, the first interactive element 212 may illustrate a map of the venue and may visually depict where the selected listing is located on the map. In some embodiments, the first interactive element 212 may include a button or feature for toggling between different views, such as a view of the venue hosting the event from the listing location and a view of a map of the venue.

The user interface 200 may include a second region 220 that may include information regarding an upgrade offering. The upgrade offering may be determined according to any of the procedures, methods, or approaches described in the present disclosure. In some embodiments, the second region may include second location information 224 of the upgrade offering (illustrated in FIG. 2 as “Upper Level 201/Row 1, Seats 1-6”). Additionally or alternatively, the second region 220 may include second price information 226. In some embodiments, the second price information 226 may provide a cost per ticket to upgrade from the selected listing. Additionally or alternatively, the second price information 226 may provide a total cost for upgrading all of the tickets (e.g., if a user had selected a quantity of six in the quantity component 218, the second price information 226 may include a total cost of upgrading six tickets). Additionally or alternatively, the second price information 226 may provide a total cost for purchasing upgraded tickets.

In some embodiments, as part of the second region 220 or as a separate element of the user interface 200, the user interface 200 may include a second interactive element 222 that may represent a visualization associated with the upgrade offering. For example, the second interactive element 222 may depict a view of the venue hosting the event from the upgrade offering location. Such a view may be a computer-generated visualization of the view, or may be a photograph of the view. In some embodiments, the second interactive element 222 may illustrate a map of the venue and may visually depict where the upgrade offering is located on the map. Additionally or alternatively, a location of the upgrade offering may be depicted on the first interactive element 212. In these and other embodiments, the listing may be depicted in a first color or by a first icon and the upgrade offering may be depicted in a second color or by a second icon.

In some embodiments, the user interface 200 may display the second region 220 as a card or other overlaying window with other potential upgrade offerings in other regions. For example, the second region 220 may be a primary upgrade offering that is selected. Other secondary upgrade offerings may be visible but not selected. The user may interact with the user interface 200 to scroll through, swipe through, or otherwise select one or more of the secondary upgrade offerings displayed on the user interface 200. In these and other embodiments, the selection of a secondary upgrade offering and/or the purchase of a secondary upgrade offering may form part of the basis for later-determined upgrade offerings. For example, after purchasing a secondary upgrade offering, the user interface 200 may include an upgrade listing similar to or even identical to the purchased secondary upgrade offering.

In some embodiments, the user interface 200 may include one or more buttons 230 or other interactive features for interacting with the user interface 200. For example, the user interface 200 may include buttons 230 for adding a viewed item to a virtual shopping cart. As another example, the user interface 200 may include buttons 230 for proceeding to pay for goods or services stored in the virtual shopping cart. The user interface 200 may include any other number of buttons for performing any other interaction with the user interface 200.

In some embodiments, the location of the region 220 on the user interface 200 may be adjusted or modified based on the display properties of a device displaying the user interface 200. For example, the location of the region 220 may be adjusted such that the region 220 appears in an initial view on a display of a device after selecting a listing. For example, with reference to the first device 120 and the second device 130 of FIG. 1, the user interface 200 may be displayed without modification or adjustment on the display 122 of the first device 120 based on the display properties of the display 122 including a large viewable area and the region 220 being visible in an initial view after selecting a listing. Continuing the example, if the display 132 has a smaller viewable area than the display 122 such that the region 220 may not be visible in an initial view after selecting an item, the user interface 200 may be adjusted by changing the location of the region 220 such that the region 220 may be included in the initial view.

Modifications, additions, or omissions may be made to FIG. 2 without departing from the scope of the present disclosure. For example, the user interface 200 may include more or fewer elements than those illustrated and described in the present disclosure. For example, the user interface 200 may include any number and/or arrangement of elements displaying information or for interacting with the user interface 200. As another example, the regions 210 and 220 and the information and elements of the regions 210 and 220 may be arranged in any order or other visual arrangement.

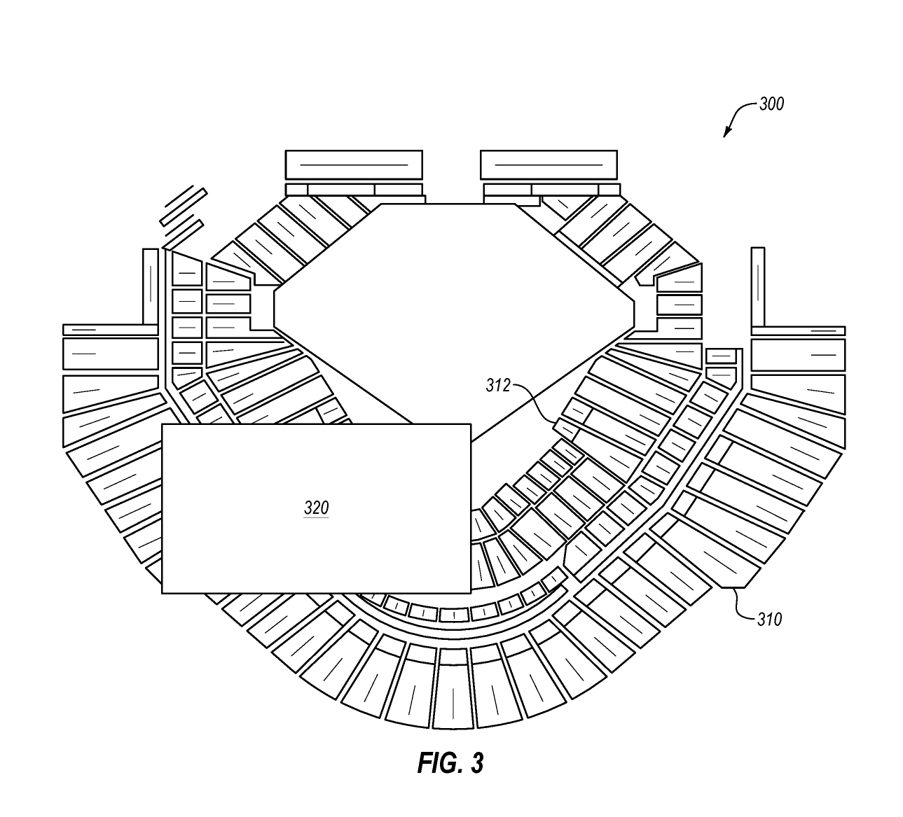

FIG. 3 illustrates an example venue map 300, in accordance with one or more embodiments of the present disclosure. The venue map 300 may be provided to a user in a number of different settings and for a number of different uses.

In some embodiments, a user interface (e.g., the user interface 200 of FIG. 2) may include the venue map 300. In these and other embodiments, the venue map 300 may be interactive. For example, a user may select a first section 310 of the venue map 300 and may be provided with a list of listings available in the section 310 (for example, in the overlaid window 320). In some embodiments, the venue map 300 may mark, highlight, or otherwise designate a location on the venue map 300 where a selected listing is located. Additionally or alternatively, the venue map 300 may mark, highlight, or otherwise designate a location on the venue map 300 where an upgrade offering is located. In these and other embodiments, the venue map 300 may mark, highlight, or otherwise designate the first section 310 where the selected listing is located and mark, highlight, or otherwise designate a second section 320 where the upgrade offering is located.

In some embodiments, the overlaid window 320 may include information related to the upgrade offering. For example, the overlaid window 320 may include information included in the second region 220 of FIG. 2.

In some embodiments, a device (e.g., the first user device 120 or the second user device 130 of FIG. 1) displaying the venue map 300 may track interactions of a user operating the device with the venue map 300. The device may provide those interactions to a server (e.g., the server 110 of FIG. 1) to be used in determining an upgrade offering for the user. For example, if the user had frequently interacted with the second section 312 but had selected a listing in the first section 310, the server may provide an upgrade offering in the second section 312.

In some embodiments, the venue map 300 may be implemented using code implemented by the device of the user (e.g., the first device 120 or the second device 130 of FIG. 1). For example, the venue map 300 may be implemented using JavaScript or Hypertext markup language (HTML). The device of the user may execute such user-device code. Based on the execution of the user-device code, the user may interact with the venue map 300 to change a configuration of the venue map 300.

For example, the venue map 300 may include elements through which a user may interact with the venue map 300. The user-device code executed by the device of the user may obtain the user interactions and change the configuration of the venue map 300 accordingly. For example, the configuration of the venue map 300 may change by changing the section of the venue displayed in the map. Alternately or additionally, the user-device code may request additional data from a server (e.g., the server 110 of FIG. 1), such as images, listings, or other information.

Modifications, additions, or omissions may be made to FIG. 3 without departing from the scope of the present disclosure. For example, the venue map 300 may include more or fewer elements than those illustrated and described in the present disclosure. For example, the venue map 300 may include any number and/or arrangement of overlaid windows, venues, sections of venues, etc.

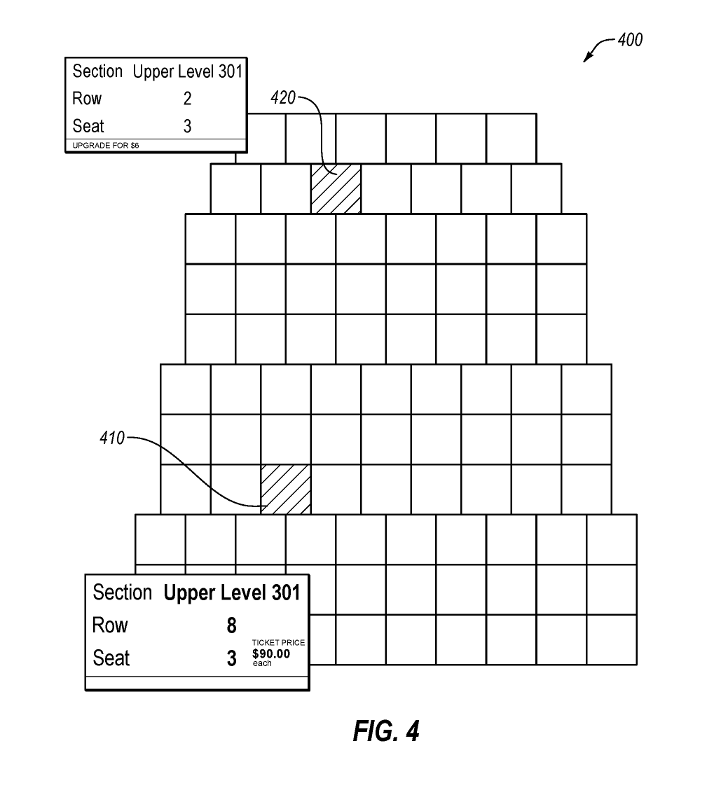

FIG. 4 illustrates another example of a venue map 400, in accordance with one or more embodiments of the present disclosure. In some embodiments, the venue map 400 may be used in place of or as a part of the user interface 200 of FIG. 2. The venue map 400 may illustrate one section of an entire venue map (e.g., the venue map 400 may illustrate individual seats of the section 310 of FIG. 3 rather than the entire venue as illustrated in FIG. 3).

The venue map 400 may identify a first location 410 as associated with a selected listing. For example, a user of a device may be viewing the venue map 400 displayed on the device and may select the first location 410, either be selecting the location or by selecting a textual description associated with the listing. In these and other embodiments, a first overlaid window 415 may be generated that may include information about the selected listing (e.g., a section, row and seat of the listing, a price of the listing, etc.).

The venue map 400 may include a second location 420 that may identify an upgrade offering. The upgrade offering may be determined according to any of the procedures, methods, or approaches described in the present disclosure. In some embodiments, the venue map 400 may include a second overlaid window 425 that may include information about the upgrade offering (e.g., a section, row and seat of the upgrade offering, a price of the upgrade offering, etc.).

In some embodiments, a user may be provided a display of the venue map 400 without the first location 410 or the second location 420 identified, highlighted, or otherwise marked. Based on the user selecting a listing associated with the first location 410, the second location 420 may be highlighted or identified and/or the second overlaid window 425 may be displayed.

In some embodiments, the venue map 400 may be formatted in a similar manner to the venue map 300 of FIG. 3. For example, portions of the venue map 400 may be formatted a first way for seats and/or locations that are associated with a selected listing, and a second way for an upgrade offering. In some embodiments, the selected listing and the upgrade offering may be formatted differently from each other and from the rest of the venue map 400.

Modifications, additions, or omissions may be made to FIG. 4 without departing from the scope of the present disclosure. For example, the venue map 400 may include more or fewer elements than those illustrated and described in the present disclosure. For example, the venue map 400 may include any number and/or arrangement of overlaid windows, venues, sections of venues, etc.

FIG. 5 illustrates a flowchart of an example computer-implemented method 500 of providing an intelligent upgrade offering, in accordance with one or more embodiments of the present disclosure. The method 500 may be performed by any suitable system, apparatus, or device. For example, the system 100 of FIG. 1 may perform one or more of the operations associated with the method 500. Although illustrated with discrete blocks, the steps and operations associated with one or more of the blocks of the method 500 may be divided into additional blocks, combined into fewer blocks, or eliminated, depending on the desired implementation.

At block 505, a selection of an item listing may be received from a user at a remote location. For example, a user operating a device (e.g., the first device 120 or the second device 130 of FIG. 1) may interact with the device to make a selection of a listing such as a seat for an event. The device may transmit the selection to a server (e.g., the server 110 of FIG. 1) remote from the device. The selection at block 505 may include a user selecting a listing to view details of the listing, adding the listing to a virtual shopping cart, selection of a location on an interactive venue map, purchasing a ticket associated with a listing, etc.

At block 510, an IP address of the remote location may be detected. For example, the server may query the IP address of the device. In these and other embodiments, a physical location may be derived from the IP address

At block 515, interactions of the user with an interactive map of a venue may be tracked. For example, the device may store data associated with interactions of the user with an interactive map and may transmit such stored data to the server. The server may track information such as what sections of a venue map the user selected, how long the user spent with a section of the venue map selected, a history of interactions with the venue map (e.g., the most recent selection or the five most recent selections of sections), etc.

At block 520, upgrade offers accepted for an event may be tracked. For example, the server may monitor upgrade offerings provided to users and may track how many users accept an upgrade. The server may track a percentage of upgrade offerings accepted for a given event, for a given venue, for a particular sporting event, for a particular sporting team, for a particular artist or performer, etc. Additionally or alternatively, a history of upgrade offers that were previously tracked or otherwise maintained may be observed, analyzed, or obtained and utilized as a basis for selecting an upgrade offering.

At block 525, a purchase history of the user may be tracked. For example, the device and/or the server may track purchases made by the user. Such purchase history may include purchases made in an e-commerce service of which the server is a part (e.g., Stub Hub®, eBay®, etc.). Additionally or alternatively, the purchase history may include any purchases made by the user, for example, to track for goods or services related to a selected listing. For example, the server may receive a purchase history of a user from a financial institution or some other entity. Additionally or alternatively, a purchase history that was previously tracked or otherwise maintained may be observed, analyzed, or obtained and utilized as a basis for selecting an upgrade offering.

At block 530, an upgrade offering may be determined. The upgrade offering may represent an offer for an improved listing when compared to the listing selected at block 505. The upgrade offering may be an intelligent upgrade offering that may be personalized to the user and/or to the event. For example, the upgrade offering may be based on any of a variety of factors, including a physical location of the user (e.g., as determined by the IP address of the user at block 510), interactions of the user with an interactive map of the venue, purchase history of the user, upgrade offering acceptances by the user, user preferences, upgrade offerings accepted for the event, the context of the event, etc.

At block 535, a price for the upgrade offering may be determined. For example, based on one or more of the factors upon which the upgrade offering may be based, the price may be determined. In some embodiments, determining the price of an upgrade offering may occur prior to determining the upgrade offering, and an upgrade offering that is consistent with the determined price may be selected. In these and other embodiments, the price may include a range of prices.

At block 540, instructions may be generated for a device at a remote location to generate a user interface. For example, the server may generate instructions for the device with which the user is interacting to generate a user interface. The user interface may include information regarding the listing selected at block 505 and/or may include information regarding an upgrade offering.

At block 545, the instructions generated at block 540 may be transmitted to the remote location. For example, the server may transmit the instructions to the device with which the user is interacting.

At block 550, display properties of the remote device may be determined. For example, the device with which the user is interacting may include settings describing the display properties of the device. Additionally or alternatively, the server may query the device regarding the display properties of the device.

At block 555, the user interface may be generated at the remote device. The user interface may include the item listing selected at block 505 and/or an interactive element for selecting the upgrade offering determined at block 530. In these and other embodiments, the interactive element for selecting the upgrade offering may be included in the initial field of view on the display of the device used by the user. In some embodiments, by selecting the interactive element, a listing associated with the upgrade offering may be added to a virtual shopping cart of the user and/or a listing being upgraded may be removed from the virtual shopping cart.

Accordingly, the method 500 may provide an intelligent upgrade offering. Modifications, additions, or omissions may be made to the method 500 without departing from the scope of the present disclosure. For example, any of the blocks 510, 515, 520, 525, 535, 550, and/or 555 may be omitted. As another example, the operations of the method 500 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

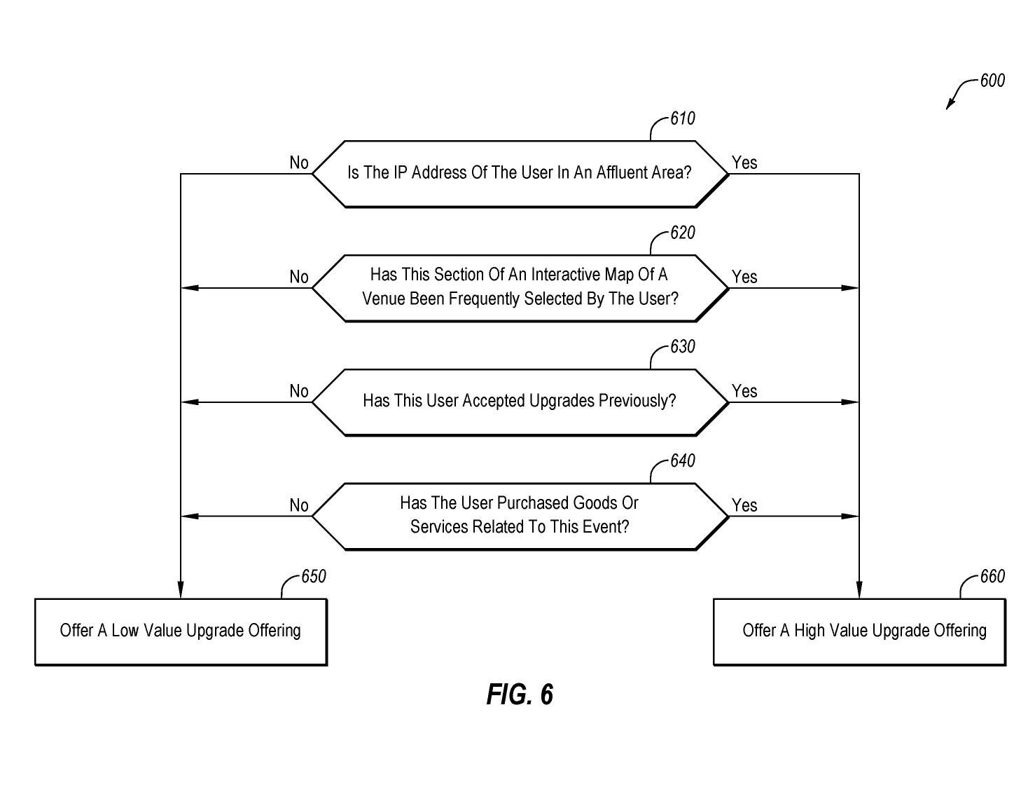

FIG. 6 illustrates a flowchart of another example computer-implemented method 600 of providing an intelligent upgrade offering, in accordance with one or more embodiments of the present disclosure. FIG. 6 illustrates a variety of factors that may form at least part of the basis for an upgrade offering and/or a price of an upgrade offering. For example, the method 600 may be an expansion of the blocks 530 and/or 535 of FIG. 5. The method 600 may be performed by any suitable system, apparatus, or device. For example, the system 100 of FIG. 1 may perform one or more of the operations associated with the method 600. Although illustrated with discrete blocks, the steps and operations associated with one or more of the blocks of the method 600 may be divided into additional blocks, combined into fewer blocks, or eliminated, depending on the desired implementation.

For the blocks 610, 620, 630, and 640, a determination may be made as to a certain factor that may form at least part of the basis for an upgrade offering. The blocks 610, 620, 630, and 640 may lead to the block 650 indicating that a low value upgrade offering may be offered or to the block 660 indicating that a high value upgrade offering may be offered. Any of the factors illustrated in the blocks 610, 620, 630, and/or 640 may be sufficient to indicate a low value upgrade offering or a high value upgrade offering. Additionally or alternatively, combinations of various factors may increase or decrease the value of the upgrade offering. Other factors not illustrated in FIG. 6 may form at least part of (or the entire basis for) the upgrade offering, as described in the present disclosure.

At block 610, a determination may be made as to whether the IP address of a user is from an affluent area. If it is determined that the IP address is not from an affluent area, the method 600 may proceed to the block 650 indicating a low value upgrade offering may be offered. If it is determined that the IP address is from an affluent area, the method 600 may proceed to the block 660 indicating a high value upgrade offering may be offered.

At block 620, a determination may be made as to whether a section of an interactive map of a venue has been frequently selected by the user. If it is determined that no sections of the interactive map of the venue have been frequently selected by the user, the method 600 may proceed to the block 650 indicating a low value upgrade offering may be offered. If it is determined that a section of the interactive map of the venue has been frequently selected by the user, the method 600 may proceed to the block 660 indicating a high value upgrade offering may be offered.

At block 630, a determination may be made as to whether the user has accepted upgrades previously. If it is determined that the user has not previously accepted upgrades, the method 600 may proceed to the block 650 indicating a low value upgrade offering may be offered. If it is determined that the user has previously accepted upgrades, the method 600 may proceed to the block 660 indicating a high value upgrade offering may be offered. Additionally or alternatively, a determination may be made as to whether other users have accepted upgrades for the event for which the user is considering listings.

At block 640, a determination may be made as to whether the user has purchased goods or services related to the event. If it is determined that the user has not purchased goods or services related to the event, the method 600 may proceed to the block 650 indicating a low value upgrade offering may be offered. If it is determined that the user has purchased goods or services related to the event, the method 600 may proceed to the block 660 indicating a high value upgrade offering may be offered.

Accordingly, the method 600 may provide an intelligent upgrade offering. Modifications, additions, or omissions may be made to the method 600 without departing from the scope of the present disclosure. Furthermore, the outlined operations and actions are provided as examples, and some of the operations and actions may be optional, combined into fewer operations and actions, or expanded into additional operations and actions without detracting from the essence of the disclosed embodiments.

As indicated above, the embodiments described herein may include the use of a special purpose or general purpose computer including various computer hardware or software modules, as discussed in greater detail below. Further, as indicated above, embodiments described herein may be implemented using computer-readable media for carrying or having computer-executable instructions or data structures stored thereon.

In some embodiments, the different components, modules, engines, and services described herein may be implemented as objects or processes that execute on a computing system (e.g., as separate threads). While some of the system and methods described herein are generally described as being implemented in software (stored on and/or executed by general purpose hardware), specific hardware implementations or a combination of software and specific hardware implementations are also possible and contemplated.

In some embodiments, the present disclosure may include a system that may include a device at a first location, the device including a display, and a server at a second location remote from the device. The server may include a processor and computer-readable instructions that, when executed by the processor, are configured to obtain previously tracked acceptances of upgrade offerings provided to a user, receive a selection of an item listing for an event from the user at the device, and determine an upgrade offering for the item listing based on multiple factors, including at least the upgrade offerings previously accepted by the user. The computer-readable instructions may additionally configure the processor to generate second instructions to be transmitted to the device to generate a user interface to be displayed on the display. The user interface may include the item listing, an interactive element for selecting the upgrade offering, a first visual element depicting a first view from the item listing at the event, and a second visual element depicting a second view from the upgrade offering at the event. The computer-readable instructions may additionally configure the processor to transmit the second instructions to the device.

In some embodiments in accordance with the present disclosure, the second instructions further instruct the device to determine display properties of the display, and locate, based on the display properties, the upgrade offering within the user interface such that the upgrade offering is within an initial field of view on the device after the selection of the item listing.

In some embodiments, the present disclosure may include a method of generating a user-interface to be displayed at a remote location. The method may include receiving a selection of an item listing for an event from a user at a remote location and determining an upgrade offering for the item listing based on previously accepted upgrade offers. The method may additionally include generating instructions to be transmitted to the remote location to generate a user interface to be displayed at the remote location. The user interface may include the item listing and an interactive element for selecting the upgrade offering. The method may also include transmitting the instructions to the remote location.

In some embodiments in accordance with the present disclosure, instructions generated for the remote location may further instruct the remote location to generate a first visual element of the user interface depicting a first view from the item listing at the event, and generate a second visual element of the user interface depicting a second view from the upgrade offering at the event.

In some embodiments in accordance with the present disclosure, the method of generating a user-interface to be displayed at a remote location may further include tracking interactions of the user with an interactive map of a venue hosting the event. In these and other embodiments, the upgrade offering may be further based on a region of the venue the user previously selected on the interactive map.

In some embodiments in accordance with the present disclosure, the method of generating a user-interface to be displayed at a remote location may further include detecting an internet protocol (IP) address of the remote location. In these and other embodiments, the upgrade offering may be further based on a location of the IP address.

In some embodiments in accordance with the present disclosure, the method of generating a user-interface to be displayed at a remote location may further include tracking purchase history of the user. In these and other embodiments, the upgrade offering may be further based on the purchase history of the user.

In some embodiments in accordance with the present disclosure, the upgrade offering may be further based on one or more context factors specific to the event.

In some embodiments in accordance with the present disclosure, the context factors specific to the event may include one or more of pre-season, regular season, play-offs, finals, number of instances of the event, number of locations of the event, league, a venue hosting the event, and percent of tickets sold to the event.

In some embodiments in accordance with the present disclosure, the previously accepted upgrade offers may include one of upgrade offers previously accepted by the user or upgrade offers previously accepted for the event.

In some embodiments in accordance with the present disclosure, instructions generated for the remote location may further instruct the remote location to determine display properties of a local display device at the remote location, and locate, based on the display properties of the local display, the upgrade offering within the user interface such that the upgrade offering is within an initial field of view on the local display device after the selection of the item listing.

In some embodiments in accordance with the present disclosure, determining an upgrade offering may include determining a price for the upgrade offering based on one or more factors used in determining the upgrade offering.

In some embodiments in accordance with the present disclosure, determining an upgrade offering may include determining a price for the upgrade offering based on a fixed percentage change of a price of the item listing or a fixed amount change of the price of the item listing.

In some embodiments in accordance with the present disclosure, a non-transitory computer-readable medium may include instructions that, when executed by one or more processors, are configured to control operations. The operations may include steps or operations associated with methods in accordance with the present disclosure.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc., connote a specific order, these terms should not be understood to connote a specific order.

All examples and conditional language recited herein are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system comprising:
a device at a first location, the device including a display; and
a server at a second location remote from the device, the server including:
a processor; and
computer-readable instructions that, when executed by the processor, are configured to:
obtain previously tracked acceptances of upgrade offerings provided to a user;
receive a selection of an item listing for an event from the user at the device;
determine an upgrade offering for the item listing based on a plurality of factors including at least the upgrade offerings previously accepted by the user;
generate second instructions to be transmitted to the device to generate a user interface to be displayed on the display, the user interface including the item listing, an interactive element for selecting the upgrade offering, a first visual element depicting a first view from the item listing at the event, and a second visual element depicting a second view from the upgrade offering at the event; and
transmitting the second instructions to the device.

2. The system of claim 1, wherein the second instructions further instruct the device to:
determine display properties of the display; and
locate, based on the display properties, the upgrade offering within the user interface such that the upgrade offering is within an initial field of view on the device after the selection of the item listing.

3. The system of claim 1, wherein the computer-readable instructions are further configured to:
query the internet protocol (IP) address of the device; and
wherein the upgrade offering is further based on a physical location of the IP address of the device.

4. A method of generating a user-interface to be displayed at a remote location, the method comprising:
receiving a selection of an item listing for an event from a user at a remote location;
determining an upgrade offering for the item listing based on previously accepted upgrade offers;
generating instructions to be transmitted to the remote location to generate a user interface to be displayed at the remote location, the user interface including the item listing and an interactive element for selecting the upgrade offering; and
transmitting the instructions to the remote location.

5. The method of claim 4, wherein the instructions further instruct the remote location to:
generate a first visual element of the user interface depicting a first view from the item listing at the event; and
generate a second visual element of the user interface depicting a second view from the upgrade offering at the event.

6. The method of claim 4, further comprising:
tracking interactions of the user with an interactive map of a venue hosting the event; and
wherein the upgrade offering is further based on a region of the venue the user previously selected on the interactive map.

7. The method of claim 4, further comprising:
detecting an internet protocol (IP) address of the remote location; and
wherein the upgrade offering is further based on a location of the IP address.

8. The method of claim 4, further comprising:
tracking purchase history of the user; and
wherein the upgrade offering is further based on the purchase history of the user.

9. The method of claim 4, wherein the upgrade offering is further based on one or more context factors specific to the event.

10. The method of claim 9, wherein the context factors specific to the event include one or more of pre-season, regular season, play-offs, finals, number of instances of the event, number of locations of the event, league, a venue hosting the event, and percent of tickets sold to the event.

11. The method of claim 4, wherein the previously accepted upgrade offers includes one of upgrade offers previously accepted by the user or upgrade offers previously accepted for the event.

12. The method of claim 4, wherein the instructions further instruct the remote location to:
determine display properties of a local display device at the remote location; and
locate, based on the display properties of the local display, the upgrade offering within the user interface such that the upgrade offering is within an initial field of view on the local display device after the selection of the item listing.

13. The method of claim 4, wherein determining an upgrade offering comprises determining a price for the upgrade offering based on one or more factors used in determining the upgrade offering.

14. The method of claim 4, wherein determining an upgrade offering comprises determining a price for the upgrade offering based on a fixed percentage change of a price of the item listing or a fixed amount change of the price of the item listing.

15. A non-transitory computer-readable medium including instructions that, when executed by one or more processors, are configured to control operations, the operations including:
receiving a selection of an item listing for an event from a user at a remote location;
tracking upgrade acceptance for the event;
determining an upgrade offering for the item listing based on previously accepted upgrade offers for the event;
generating second instructions to be transmitted to the remote location to generate a user interface to be displayed at the remote location, the user interface including the item listing and an interactive element for selecting the upgrade offering; and
transmitting the second instructions to the remote location.

16. The computer-readable medium of claim 15, wherein the second instructions further instruct the remote location to:
generate a first visual element of the user interface depicting a first view from the item listing at the event; and
generate a second visual element of the user interface depicting a second view from the upgrade offering at the event.

17. The computer-readable medium of claim 15, further comprising:
tracking interactions of the user with an interactive map of a venue hosting the event; and
wherein the upgrade offering is further based on a region of the venue the user previously selected on the interactive map.

18. The computer-readable medium of claim 15, further comprising:
detecting an internet protocol (IP) address of the remote location; and
wherein the upgrade offering is further based on a location of the IP address.

19. The computer-readable medium of claim 15, wherein the upgrade offering is further based on one or more context factors specific to the event, the context factors specific to the event including one or more of pre-season, regular season, play-offs, finals, number of instances of the event, number of locations of the event, league, a venue hosting the event, and percent of tickets sold to the event.

20. The computer-readable medium of claim 15, wherein the second instructions further instruct the remote location to:
determine display properties of a local display device at the remote location; and
locate, based on the display properties of the local display, the upgrade offering within the user interface such that the upgrade offering is within an initial field of view on the local display device after the selection of the item listing.
